(19) United States
(12) Patent Application Publication
(10) Pub. No.: US 2006/0267366 A1
(43) Pub. Date: Nov. 30, 2006

(54) 4-Bar freeplay cam

(75) Inventor: Kurt A. Seibold, South Lyon, MI (US)

Correspondence Address: FOLEY & LARDNER LLP, 777 EAST WISCONSIN AVENUE, MILWAUKEE, WI, 53202-5306, US

(73) Assignee: Johnson Controls Technology Company

(21) Appl. No.: 11/435,396

(22) Filed: May 16, 2006

Related U.S. Application Data
(60) Provisional application No. 60/681,371, filed on May 16, 2005.

(51) Int. Cl. B60R 7/04; B60N 2/02

(52) U.S. Cl. 296/65.05; 296/37.15

(57) ABSTRACT

An arrangement for a 4-bar system of a stowable vehicle seat to allow the 4-bar system to move over-center without binding, with the 4-bar system including a grounded leg, a rear leg, a cushion member and a front leg. The arrangement comprises a cam coupled to the front leg. A stop pin is mounted on the cushion member and aligned to engage the cam. An elongated slot is defined in the cushion member and configured to receive a pivot pin coupled to the front leg. A release lever is defined on the front leg and configured to contact the cam. As the 4-bar system goes over-center, the cam pivots away from the stop allowing the front leg to move in the slot as the vehicle seat is stowed. This freedom of motion, allows the vehicle seat to go over-center during the stowing procedure.

### CROSS-REFERENCE TO RELATED PATENT APPLICATIONS

This application claims the benefit of U.S. Provisional Application No. 60/681,371, filed May 16, 2005, which is incorporated herein by this reference.

### FIELD OF THE INVENTION

The present invention relates generally to the art of vehicle seating, and more particularly to a freeplay cam in a 4-bar mechanism of a vehicle seat.

### BACKGROUND OF THE INVENTION

It is known in the art that vehicle seats are configured to fold for purposes of storage of the vehicle seat in a stow tub formed in the floor of the vehicle. Such storage increases the cargo carrying capability of the vehicle such as in an SUV or van. Due to the type of packaging on many vehicles, a vehicle seat may go over-center. As a result, additional effort to manipulate the seat is needed or alternatively, a very complex system is required to stow the seat.

Thus there is a need for a vehicle seat structure, when in a stowed condition that consumes no more space than a conventional seat. There is a further need for an arrangement in the 4-bar system of a vehicle seat to provide freeplay to allow the 4-bar system to complete its motion with a minimal amount of effort.

### SUMMARY OF THE INVENTION

There is provided an arrangement for a 4-bar system of a stowable vehicle seat to allow the 4-bar system to move over-center without binding, with the 4-bar system including a grounded leg, a rear leg, a cushion member and a front leg. The arrangement includes a cam coupled to the front leg. A stop pin is mounted on the cushion member and aligned to engage the cam. An elongated slot is defined in the cushion member and configured to receive a pivot pin coupled to the front leg. A release lever is defined on the front leg and configured to contact the cam. Before the 4-bar system goes over-center, the cam pivots away from the stop pin allowing the front leg to move in the slot as the vehicle seat is stowed. This freedom of motion, allows the vehicle seat to go over-center during the stowing procedure.

There is also provided a vehicle seat coupled to a vehicle floor with the seat being moved to one of a stowed position and an unstowed position. The vehicle seat includes a 4-bar system having a grounded leg, a rear leg, a cushion member and a front leg. The vehicle seat includes a seat back and a seat cushion. The seat cushion contains a cushion member and is coupled to the seat back and the vehicle floor. A 4-bar freeplay cam arrangement is coupled to the 4-bar system. The 4-bar freeplay cam arrangement includes a cam coupled to the front leg. A stop pin is mounted on the cushion member and aligned to engage the cam. An elongated slot is defined in the cushion member and configured to receive a pivot pin coupled to the front leg. A release lever is defined on the front leg and configured to contact the cam. As the 4-bar system rotates, the cam pivots away from the stop pin allowing the front leg to move in the slot as the 4-bar goes over-center allowing the vehicle seat to be stowed.

There is also provided a method for allowing a 4-bar system of a stowable vehicle seat coupled to a vehicle floor to move over-center without binding. The 4-bar system includes a grounded leg, a rear leg, a cushion member and a front leg. The method comprises coupling a cam to the front leg, mounting a stop pin on the cushion member to engage the cam, coupling a pivot pin to the front leg, defining an elongated slot in the cushion member and configured to receive the pivot pin, coupling a release lever to the front leg and configured to contact the cam; and moving the vehicle seat. As the 4-bar system goes towards over-center, the release lever causes the cam to pivot away from the stop pin allowing the pivot pin on the front leg to move in the elongated slot providing free play in the 4-bar system without binding.

### BRIEF DESCRIPTION OF THE DRAWINGS

FIG. 1 is a perspective view of a vehicle seat in an unstowed position and having a 4-bar system including a 4-bar freeplay arrangement to facilitate stowing of the seat.

FIG. 2 is a perspective view of the vehicle seat illustrated in FIG. 1 in a stowed position in a stow tub in the floor of the vehicle.

FIG. 3 is a partial side view of an exemplary embodiment of a 4-bar system coupled to a vehicle seat in an unstowed position, including a 4-bar freeplay arrangement.

FIG. 4 is a partial side view of the 4-bar system illustrated in FIG. 3, with the vehicle seat in a stowed position.

FIG. 5 is a partial, detailed view of an exemplary embodiment of a 4-bar freeplay arrangement at the juncture of the front leg and cushion member of a 4-bar system coupled to a vehicle seat.

### DETAILED DESCRIPTION OF EXEMPLARY EMBODIMENTS

Before beginning the description of exemplary embodiments of the present invention, several general comments can be made about the applicability and scope thereof.

First, while automotive seating may be referred to in the following portions of the specification, the invention is useful in all types of vehicle seating including, but not limited to automobiles, sport utility vehicles, vans, trucks, busses, and the like, where it is desirable to stow one seating component with respect to another.

Second, the following discussion and illustrations generally are directed to a 4-bar freeplay cam included in a 4-bar system of a vehicle seat that minimizes the packaging environment when the seat is stowed. However, depending on the construction of the seat cushion structure, seat latch, and the recliner mechanism, other parts can be mechanically locked according to the scope and teaching of the specification. Furthermore, the components can be orientated other than as illustrated but still provide the operation of a stowable seat back apparatus for a vehicle seat as described herein.

Third, with respect to the materials for the construction of the 4-bar system, apparatus or vehicle seat, components, materials currently in use, such as steel or aluminum, are entirely appropriate as well as others selected by those skilled in the specification and materials for use in vehicle seating. Strength, welding capabilities, fabrication and adaptability would be factors considered by one skilled in the art seeking to adapt to the teachings of the present invention to a particular collapsing truss that completes a four-bar mechanism of the vehicle seat.

Fourth, it may be desirable to weld the 4-bar system components to the vehicle seat, however, it should be understood that other means of fastening such as bolting or riveting or an appropriate adhesive (epoxy) can be utilized. However, any means of coupling the 4-bar system to a vehicle seat should be done to also minimize or eliminate BSR issues, as well as the need to precisely hold the relative position of the components for subsequent operation such as trim out and installation.

Fifth, for purposes of this disclosure, the term “coupled” means adjoining of two components (electric or mechanic) directly or indirectly to one another. Such joining may be stationary in nature or movable in nature. Such joining may be achieved with the two components (electric or mechanical) and any additional intermediate members being integrally formed as a single unitary body with one another or with the two components or the two components and any additional member being attached to one another. Such joining may be permanent in nature or alternatively may be removable or releasable in nature.

It should be understood that when referring to a direction such as forward or rearward, reference is being made to the general direction of the vehicle movement in relation to the driver. Also reference to a row of seats typically is the first row being the row in which the driver sits with subsequent rows identified consecutively.

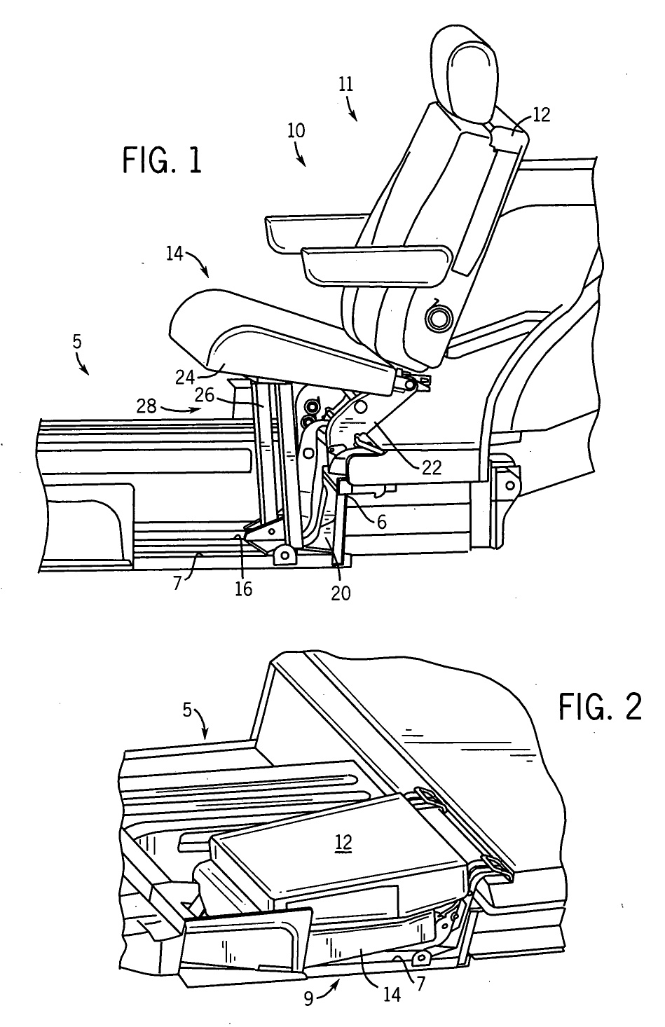

Referring to the FIGS. 1-2, there is illustrated in FIG. 1, a vehicle seat 10 including a seat cushion structure 14 coupled to a seat back 12 with an exemplary embodiment of a 4-bar freeplay arrangement 28. The vehicle seat 10 is coupled to the floor 6 of the vehicle 5. The vehicle seat 10 may include a seat control to adjust the seat in several configurations. The seat control may be manually operated or coupled to an actuator, for example, an electric motor. The vehicle seat 10 is coupled to the vehicle floor system 6 and typically includes a seat leg at the front 26 of the seat cushion structure 14. A rail system 16 may also be utilized to facilitate configuration of the vehicle seat 10.

FIG. 1 illustrates the vehicle seat 10 in an unstowed position 11, which is also referred to as a design position. FIG. 2 illustrates the vehicle seat 10 in a stowed position 9 in a stow tub 7 formed in the vehicle floor 6.

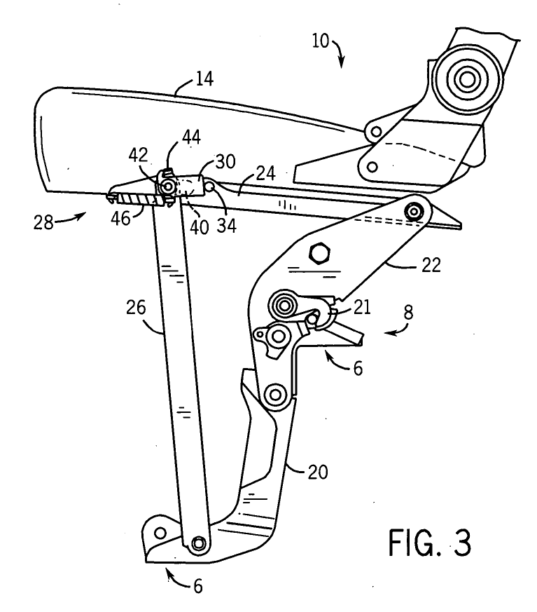

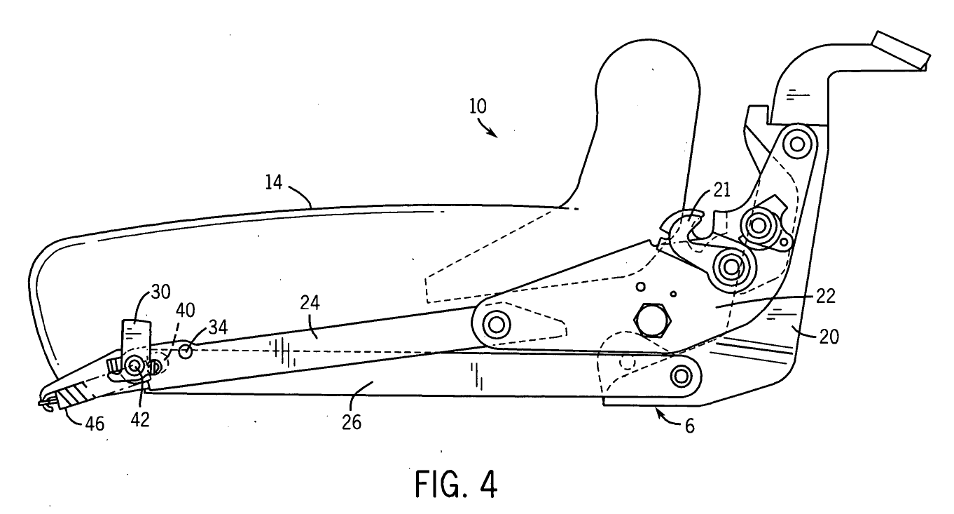

Referring to FIGS. 3-5, a 4-bar system 8 is coupled to the vehicle seat 10 and the floor 6 of the vehicle 5. The 4-bar system 8 of the stowable vehicle seat 10 includes a grounded leg 20, a rear leg 22, a cushion member 24, and a front leg 26. The rear leg 22 is coupled to the grounded leg with a pivot pin and a latch 21, and to the cushion seat structure 14. The cushion member 24 is included in the seat cushion structure 14. At least one front leg 26 is coupled to the grounded leg 20 and the cushion member 24. The 4-bar system 8 can also include pivot pins, fasteners, latches, and actuators. In order to allow the 4-bar system 8 to move over-center without binding, a 4-bar freeplay arrangement 28 is included in the 4-bar system 8. The latch 21 engages a latch pin to maintain the rear leg 22 and seat 10 in an unstowed position (FIG. 3). To move the seat 10 to a stowed position (FIG. 4), the latch 21 is moved off the latch pin thereby allowing the seat back and cushion 14 to fold to the stowed position. The latch 21 may be operated manually or by a suitable actuator.

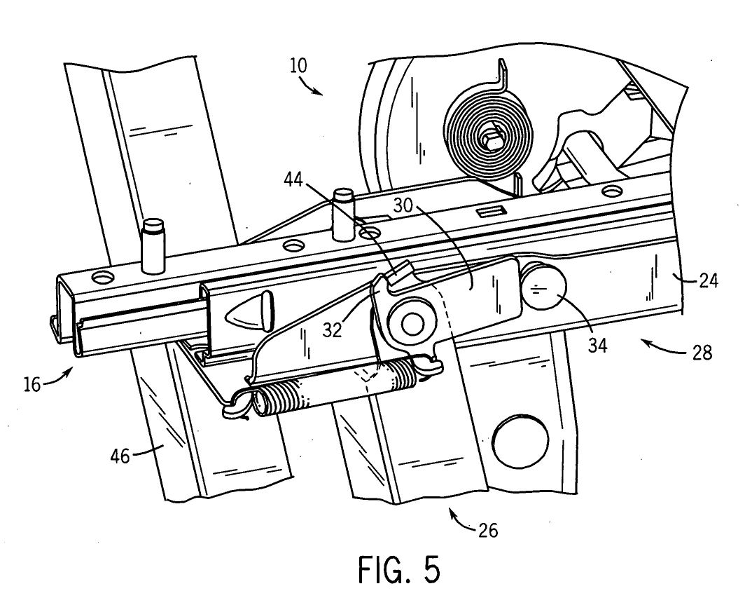

The arrangement includes a cam 30 which is coupled to the front leg 26. As seen in FIG. 5, the cam 30 includes a cam arm 32 which can be formed on the cam 30. The cam is coupled to the front leg 26 and the cushion member 24 by a pivot pin 42. It should be understood that another suitable device can be used, for example, a hook, can be substituted for the cam 30. The hook can be configured to engage the stop pin 34 or similar device. For the stow procedure, described below, the hook is disengaged from the stop pin 34 thereby allowing the front leg 26 and pivot pin 42 to move as the seat 10 is stowed.

A stop pin 34 is mounted on the cushion member 24 and aligned to engage the cam 30. When the front leg 26 as seen in FIG. 3, is in the upright or designed position, the cam 30 is in contact with the stop pin 34. As will be explained below, when the front leg 26 is in the stowed position, as illustrated in FIG. 4, the cam 30 is rotated away from the stop pin 34 by a release lever 44 coupled to the front leg 26 (see FIG. 5). An elongated slot 40 is defined in the cushion member 24 and configured to receive the pivot pin 42. The pivot pin 42 reciprocally slides within the slot 40 as the front leg 26 moves from the unstowed to stowed position and back again. (See FIGS. 3 and 4) As the 4-bar system 8 goes over-center, the cam 30 pivots away from the stop 34 allowing the front leg 26 to move in the slot 40 as the vehicle seat is stowed. Such action removes the chuck created by the slot in the 4-bar system 8 once the 4-bar system 8 of the vehicle seat 10 starts to rotate, the release lever 44 engages the cam arm 32 which rotates the cam 30 about the pivot pin 42 and disengages the cam 30 from the stop pin 34 before the system starts to go over-center. This provides the freeplay necessary to allow the 4-bar system 8 to complete its motion. The front leg 26 moves to the position illustrated in FIG. 4 as the seat 10 is lowered into the stow tub 7 of the vehicle floor 6 with the seat 10 being in a stowed position 9 as illustrated in FIG. 2.

As the vehicle seat 10 is moved from the stowed position 9 to the unstowed position 11, the front leg 26 of the 4-bar system 8 moves to the unstowed position or design position 11 as illustrated in FIG. 3. An engagement spring 46 which is coupled to the cam 30. The spring 46 pulls the front leg 26 against a stop in the slot 40 and pulls the cam 30 which pivots about the pivot pin 42 until the cam 30 again engages the stop pin 34 which prevents further movement of the pivot pin 42 in the elongated slot 40 of the cushion member 24. At that point, the vehicle seat 10 is in the unstowed or design position 11.

A suitable means of coupling the various components together may include pins, rivets, bolts and the like. Further, actuators may be coupled to the various members of the 4-bar system 8 to facilitate movement of the seat 10 from its design position 11 to a stowed position 9. Appropriate controls coupled to the actuators can be located adjacent to the vehicle seat 10 or at some other convenient location in the vehicle.

Thus there is provided a 4-bar freeplay cam that completes a four-bar mechanism of a vehicle seat that minimizes the required packaging environment when the seat is stowed. However, it should be understood that the scope is not limited thereby. For example, while the illustrated and described embodiments refer to a 4-bar system being coupled to the seat cushion and seat back, the 4-bar system could also be coupled to a seat adjustment mechanism of the vehicle seat. The 4-bar freeplay cam system can be configured for any of the four corners of the 4-bar system, i.e., where any of adjacent 4-bar members are coupled together. Various modifications of components thereof are possible and will be readily identified by persons skilled in the art. The details of the disclosed 4-bar freeplay cam, specified above, are only intended to illustrate and not to limit the present invention.

What is claimed is:

1. An arrangement for a 4-bar system of a stowable vehicle seat coupled to a vehicle floor to allow the 4-bar system to move over-center without binding, with the 4-bar system including a grounded leg, a rear leg, a cushion member and a front leg, the arrangement comprising:
a cam coupled to the front leg;
a stop pin mounted on the cushion member and aligned to engage the cam;
an elongated slot defined in the cushion member and configured to receive a pivot pin coupled to the front leg; and
a release lever defined on the front leg and configured to contact the cam;
wherein, as the 4-bar system goes over-center, the cam pivots away from the stop pin allowing the front leg to move in the slot as the vehicle seat is stowed.

2. The arrangement of claim 1, including an engagement spring coupled to the cam and the cushion member, wherein the spring biases the cam against the stop when the front leg moves in the elongated slot as the vehicle seat is unstowed.

3. The arrangement of claim 1, including a cam arm defined on the cam and configured to engage the release lever to move the cam away from the stop pin.

4. The arrangement of claim 1, including a latch coupled to the rear leg and configured to maintain the vehicle seat in an unstowed position.

5. The arrangement of claim 1, including a rail system coupled to the vehicle floor and the vehicle seat.

6. A vehicle seat coupled to a vehicle floor and that can be moved to one of a stowed position and unstowed position, including a 4-bar system having a grounded leg, a rear leg, a cushion member and a front leg, the vehicle seat comprising:
a seat back;
a seat cushion containing the cushion member and coupled to the seat back and the vehicle floor; and
a 4-bar free play cam arrangement coupled to the 4-bar system, arrangement comprising:
a cam coupled to the front leg;
a stop pin mounted on the cushion member and aligned to engage the cam;
an elongated slot defined in the cushion member and configured to receive a pivot pin coupled to the front leg; and
a release lever defined on the front leg and configured to contact the cam;
wherein, as the 4-bar system goes over-center, the cam pivots away from the stop allowing the front leg to move in the slot as the vehicle seat is stowed.

7. The vehicle seat of claim 6, including an engagement spring coupled to the cam and the cushion member, wherein the spring biases the cam against the stop when the front leg moves in the elongated slot as the vehicle seat is unstowed.

8. The vehicle seat of claim 6, including a cam arm defined on the cam and configured to engage the release lever to move the cam away from the stop pin.

9. The vehicle seat of claim 6, including a latch coupled to the rear leg and configured to maintain the vehicle seat in the unstowed position.

10. The vehicle seat of claim 6, including a rail system coupled to the vehicle floor and the vehicle seat.

11. A method for allowing a 4-bar system of a stowable vehicle seat coupled to a vehicle floor to move over-center without binding, the 4-bar system includes a grounded leg, a rear leg, a cushion member and a front leg, the method comprising:
coupling a cam to the front leg;
mounting a stop pin on the cushion member to engage the cam;
coupling a pivot pin to the front leg;
defining an elongated slot in the cushion member and configured to receive the pivot pin;
coupling a release lever to the front leg and configured to contact the cam; and
moving the vehicle seat,
wherein as the 4-bar system goes over-center, the release lever causes the cam to pivot away from the stop pin allowing the pivot pin on the front leg to move in the elongated slot providing free play in the 4-bar system without binding.

12. The method of claim 11, including the step of coupling an engagement spring to the cam and the cushion member, wherein the spring biases the cam against the stop when the front leg moves in the elongated slot as the vehicle seat is unstowed.

13. The method of claim 11, including the step of defining a cam arm on the cam configured to engage the release lever to move the cam away from the stop pin.

14. The method of claim 11, including the step of coupling a latch to the rear leg configured to maintain the vehicle seat in an unstowed position.

15. The method of claim 11, including the steps of coupling a rail system to the vehicle floor and coupling the vehicle seat to the rail system.
